(19) United States
(12) Patent Application Publication
(10) Pub. No.: US 2014/0344014 A1
(43) Pub. Date: Nov. 20, 2014

(54) VEHICLE DEALER MANAGEMENT SYSTEM APPARATUS AND RELATED METHODS

(71) Applicant: Joseph Peter MacInnis, Ladera Ranch, CA (US)

(72) Inventor: Joseph Peter MacInnis, Ladera Ranch, CA (US)

(21) Appl. No.: 14/216,085

(22) Filed: Mar. 17, 2014

Related U.S. Application Data
(60) Provisional application No. 61/800,079, filed on Mar. 15, 2013.

(51) Int. Cl. G06Q 30/02; G06Q 10/08

(52) U.S. Cl. CPC G06Q 30/0201; G06Q 10/087
USPC 705/7.29

(57) ABSTRACT

Methods and apparatus are disclosed for vehicle dealership management and similar activities. Embodiments facilitate monitoring and tracking and managing one of more of the following types of data, preferably in virtually real-time, for purposes of test drives and other activities of the dealership (or for other activities involving a store's inventory, whether vehicles or otherwise): customers, vehicle inventory, sales personnel, financial and credit information related to the inventory and/or the customers, and other information. Embodiments of the invention assist in management of vehicle dealerships or other “dealer-financed” sales outlets, using computer and Internet tools and methods and apparatus to capture, track, coordinate, and use information regarding past and potential customers, inventory, salespeople and their efforts and interactions with specific customers, financing and/or insuring purchases by such customers, and other related items.

This application is based on and claims priority to U.S. provisional application Ser. No. 61/800,079, filed Mar. 15, 2013.

This invention relates broadly to management of vehicle dealerships or other “dealer-financed” sales outlets, and more specifically to computer and Internet tools and methods and apparatus to capture, track, coordinate, and use information regarding past and potential customers, inventory, salespeople and their efforts and interactions with specific customers, financing and/or insuring purchases by such customers, and other related items.

Persons of ordinary skill in the art will understand that the processes and apparatus described herein are not intended to be delimiting, but instead are representative of the many embodiments in which the inventions may be practiced. These and other embodiments will become readily apparent to those skilled in the art from the following detailed description of embodiments having reference to the attached figures, the invention not being limited to any particular preferred embodiment(s) disclosed.

### BRIEF DESCRIPTION OF THE DRAWINGS

FIG. 1 illustrates a screenshot of one embodiment of the invention, listing items such as customer name, salesperson, whether a test drive occurred and its status (complete or not), and other data.

FIG. 2 is a block diagram, in which each block represents a stand-alone access point option to the lead management system, the credit application underwriting and approval, and financing process. It includes a mobile app to be used on a cell phone, and a virtual inventory application that forms part of a virtual dealership embodiment of the invention.

FIG. 3 also is a block diagram, and is specific to the various services that are integrated from the information extracted from the system, including validation of authenticity, identifying the sales person connected with the customer, the name and address of the customer automatically fed into credit application, the particular vehicle the customer is looking at or test driving, the tracking of the test drive departure and return, all of which can be saved to the CRM of the dealership.

FIGS. 4A through 4J are selected screenshots for a mobile phone app in accordance with the invention. Persons of ordinary skill in the art will understand that these same or similar user interfaces may be utilized in tablets, desktops, and other embodiments of the invention.

FIG. 5 is a screenshot of an embodiment of the invention, indicating that a scanned driver license has been verified as genuine.

FIG. 6 is related to FIG. 5, but shows an embodiment of the “granular” data that preferably is checked by the system as part of the automated validation of a driver license or other ID.

FIG. 7 is similar to FIG. 6, but shows the images captured that display the specific “granular” data.

FIG. 8 shows a screenshot of an embodiment of the invention displaying data for a customer in the database, and illustrating how a vehicle and/or salesperson can be selected to associate with that customer. For privacy reasons, certain personal ID information has been blacked out in FIG. 8.

FIG. 9 is similar to FIG. 5, but illustrates how a “fail” result may be presented to a user of the system of the invention, for a given scanned customer ID.

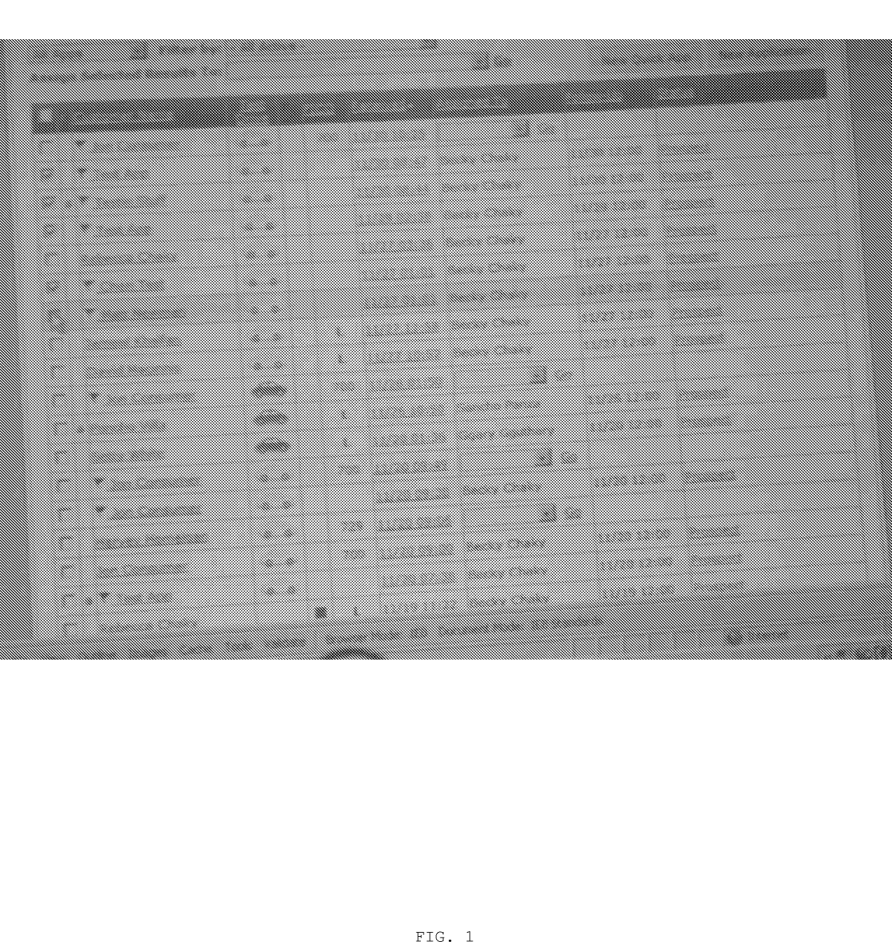

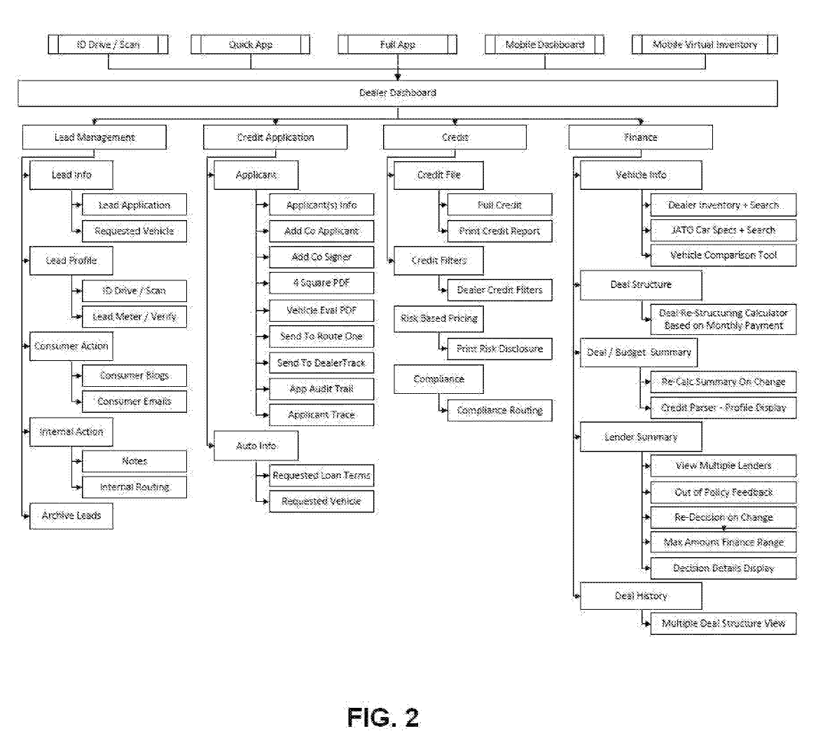

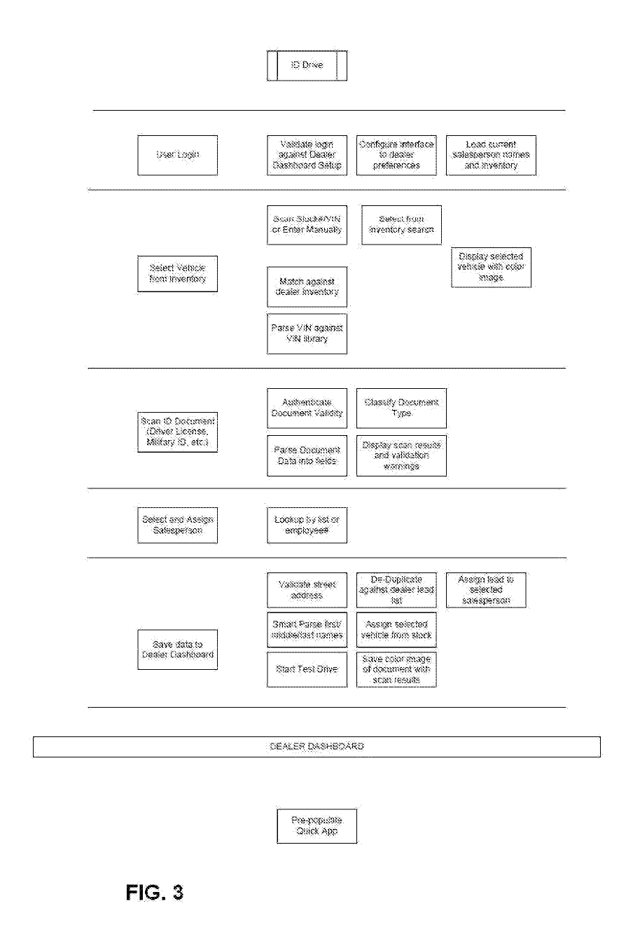

### DETAILED DESCRIPTION OF EMBODIMENTS

As indicated above, the inventions disclosed herein can be used in a broad range of applications and provide many benefits. Embodiments of the present invention will now be described with references to the accompanying figures, wherein like reference numerals refer to like elements throughout.

Persons of ordinary skill in the art will understand that the apparatus of the invention and variations of its many methods can be practiced using any of a wide variety of suitable processes and materials, in a wide variety of different goods and services being sold, and on a wide variety of computer hardware/software/environments.

The examples discussed herein primarily relate to vehicle dealerships, but as indicated elsewhere, the invention may be practiced in many other situations and circumstances.

Using a vehicle dealership as an example, one common activity of prospective customers is test driving the vehicles. Commonly, a prospective customer drives or walks into a dealership, talks briefly with a salesperson, and presents the customer's driver license to the salesperson. The salesperson walks to the dealership's copy machine, copies the driver license, gets the keys to the vehicle to be test-driven, and returns to the customer and the vehicle, whereupon the test drive begins. Among other problems discussed herein, this prior art approach may undesirably increase the risks and opportunities for identity theft (and the apparatus and methods of the invention can be used to reduce such risks of identity theft).

Because (as described above) the salesmen hang out in the parking lot and commonly approach customers outside the actual dealership building, many customers never even come “into” the dealership in connection with their test drive. As a consequence, the dealer/owner never has a record of how many customers came in, how many test drives occurred, how long the test drives lasted, which vehicles were driven, which salesmen did the test drives (and with which customers), or other relevant and potentially valuable and helpful data. The scope of the issue is not insubstantial—a large dealership may have up to 150 vehicle test drives on a given Saturday, and at the end of that day, the dealer may have information relating only to the few sales that were actually completed (rather than for most or all of the 150 test drives).

Even one day's data would be valuable, and with each day that passes without capturing the data, the cumulative quantity of “missed” data grows. Some of this customer/human “traffic” into a given dealership includes persons who have researched the vehicles and/or dealership online, and may even have registered certain information with the dealer's website or through other means. However, some substantial portion of that traffic has not made any such preliminary contact or registration with the dealer. In any case, whether pre-registered or not, the process described above is a common practice at vehicle dealerships.

Among the benefits of the present invention is the ability to easily capture relevant data about ALL such customers as they embark upon the test drive process mentioned above. Other aspects of the invention are discussed herein, and may be combined with the “customer data capture” process or may be practiced independently in certain embodiments of the invention.

Because the initial engagement by salespersons with these potential customers frequently is to get the customer's driver license (as described above), in certain embodiments of the invention the salesperson scans in that driver license via appropriate technology (such as described herein) and electronically captures relevant data from it. In various embodiments, the system can include software and systems for immediately and automatically populating an electronic database with the data, and/or authenticating/validating it by checking it against credit/financing databases or other records.

This type of technology is available from a company named AssureTec (http://www.AssureTec.com/) and it can be used in various embodiments of the invention. AssureTec is in the ID verification and fraud prevention business, and has products that allow scanning of driver licenses, passports, and/or other legal identification documents, and automatic extraction of data from that ID and authentication and/or validation of same. For the latter, the AssureTec or similar technology can be used to compare the information from the ID with existing electronic databases of records, and report as to pass/fail on various verification data.

The AssureTec system already is used in at least some international border crossings, and it covers most driver licenses from most countries. Using a California driver license as an example, each such license includes approximately 29 different security indicia, all of which preferably can be checked by a preferred device/scanner from Assuretec. As noted above, many aspects of the invention can be practiced WITHOUT using such a scanning/info retrieval device or method. Among other things, just a basic scan and OCR of the driver license is useful for many aspects and embodiments of the invention.

Persons of ordinary skill in the art will understand that a wide range of apparatus can be used to capture information relating to a potential customer at a vehicle dealership, to then be used as described herein. Many of the benefits of the invention can be enjoyed regardless of whether the “fraud check” step or apparatus is included as part of any particular embodiment of the invention.

Basically, and although not required in certain embodiments of the invention, this type of technology can check and cross-check the ID with various sources of online or other data, to report as to whether the ID appears to be authentic and whether there is any concern about the bona fides of the person (who gave the driver license to the dealer/salesperson). If the ID appears to be fraudulent, the dealer/salesperson can stop the process and not work further on the potential sale, and/or not allow the customer to test drive any of the dealer's vehicles. Among other things, this can help reduce the risk of theft or malfeasance by such an unverifiable customer.

The system preferably signals the dealer/salesman as to any such risk relatively immediately following the scanning of the ID. In certain embodiments, a color code can be displayed (e.g., red for STOP—don't proceed with this customer; yellow—there may be a problem; or green—this customer appears to be a good/verified prospect). The report can be presented in granular form—a red/yellow/green flag adjacent individual items of data that either pass/fail/etc. —as well as an overall red/yellow/green/other flag for the overall rating/verification of the customer.

In addition to verifying the customer's data/ID and/or enabling the dealer to track those potential customers, the invention preferably further ties the customer data captured from the driver license (and/or from that entered by the customer over the Internet or via some other means) to one or more vehicles from the dealer's inventory. The system preferably also integrates the record the dealer's inventory system (VIN or Stock number or other), allows it to be connected to the relevant salesperson, solicit and optionally input other data such as the customer's phone number and email address (to be able to immediately send to the customer an electronic brochure for the selected vehicle, permit future email communications with the customer, etc.).

The system preferably then validates the customer's address and other information, such as by going out over the Internet to confirm that this person actually lives at the indicated address, has the indicated phone number, etc.

The system also preferably checks whether the customer/data ALREADY is in the system, and it may export the data into a secure electronic environment. Preferably the system/software also allows the customer to input SSN or other info so that the dealer can be processing and pre-approving the customer for a financed sale/lease/etc.

The system preferably also includes an inventory component to search/locate vehicle(s) that may be within this customer's credit ratings/income/make and model of vehicle, etc.

Preferably the data and other relevant information/fields are presented in some readily usable form, for use by the dealer, salesman, finance manager.

The system also preferably converts the captured/entered data into a full credit application (and/or as close to a full application as possible). In preferred embodiments, reports can be printed or otherwise processed, emailed, etc. in a wide variety of forms and communication systems. Certain embodiments of the invention auto-populate applications and other forms that previously required manual entry of data (or even handwritten forms). The system preferably provides an improved quality control of the data entered (address, etc.) so that the dealer and the dealer's staff can better rely on it to send to customers (including persons who end up BUYING vehicles from the dealer) communications such as handwritten thank you notes, etc.

The system preferably allows one or more sales managers or salespersons or other personnel to turn on a timer to indicate that the test drive is starting/ending (and thereby calculate how long the test drive lasted), and can flag/track the specific car from the inventory that is being driven and the salesperson who conducted the test drive. GPS sensors on the vehicles can also capture data that can be integrated with the other records of the test drive, and a proximity sensor or other system can be used to verify the identity of the salesperson conducting the test drive.

Preferably, the system provides virtually real-time reports to dealership management regarding a range of useful metrics. Examples include:
1. How many test drives occurred in a given time frame?
2. Which salespersons conducted those test drives?
3. Which vehicle(s)/model(s)/etc. were driven, and for how long a time, how many miles, etc.?

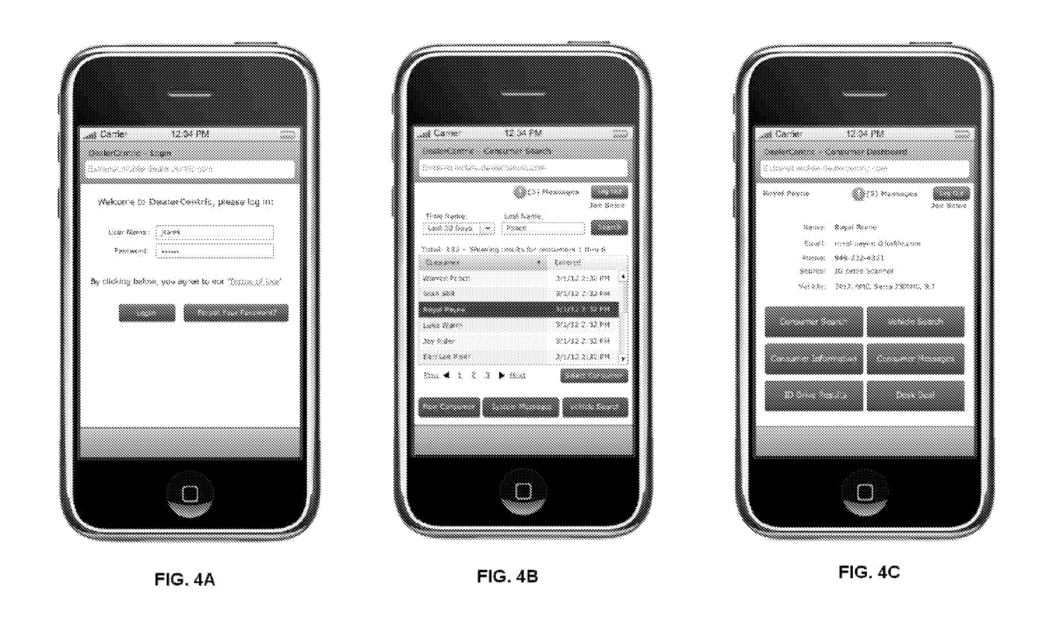

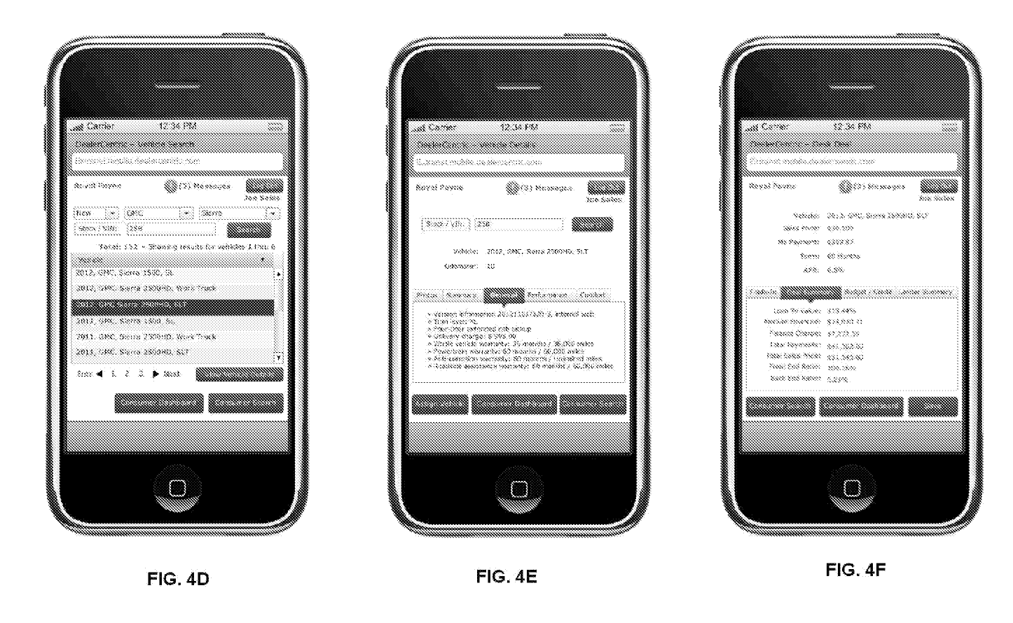

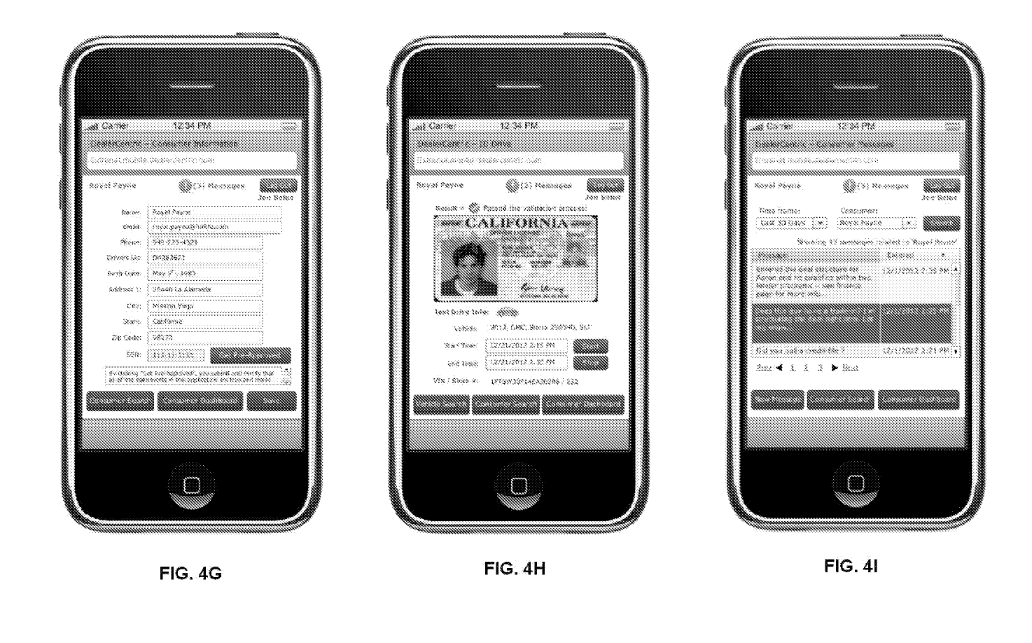

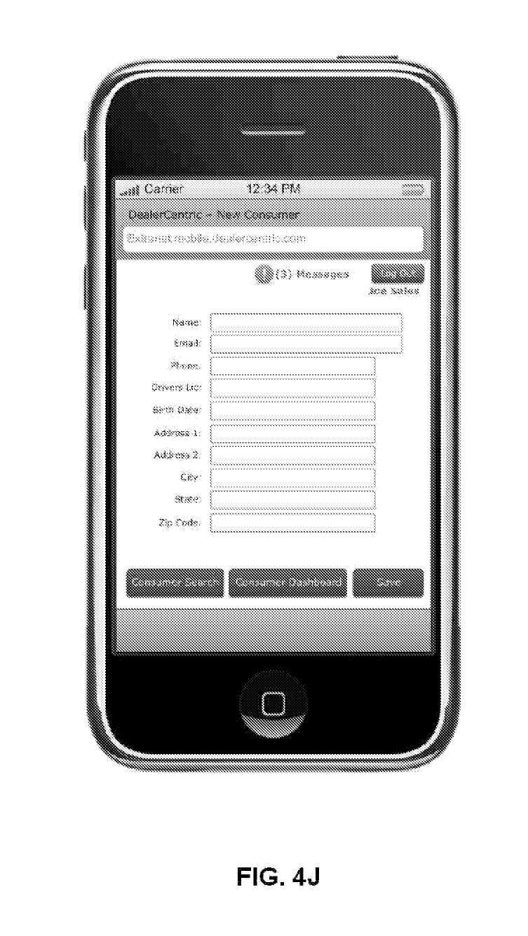

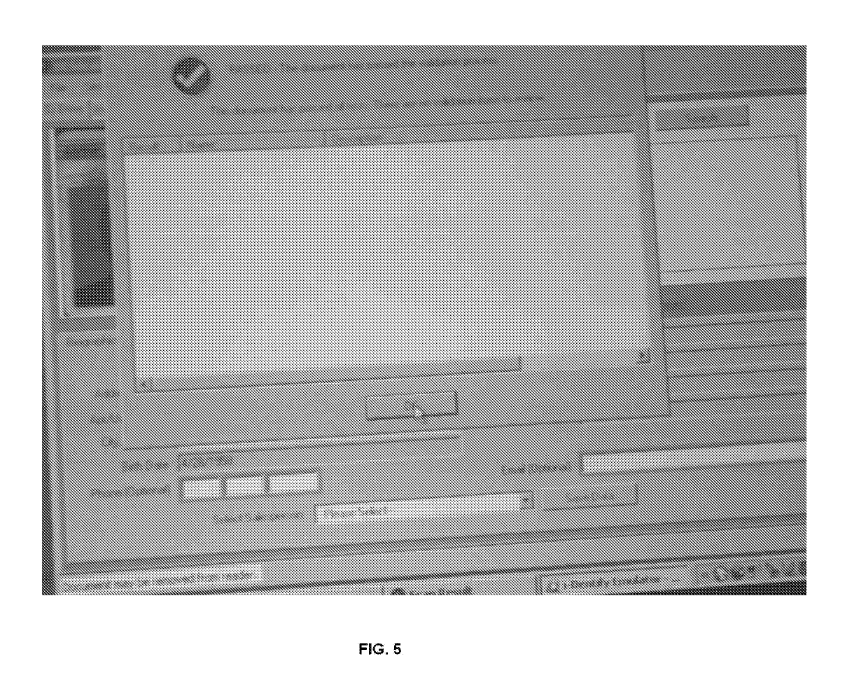

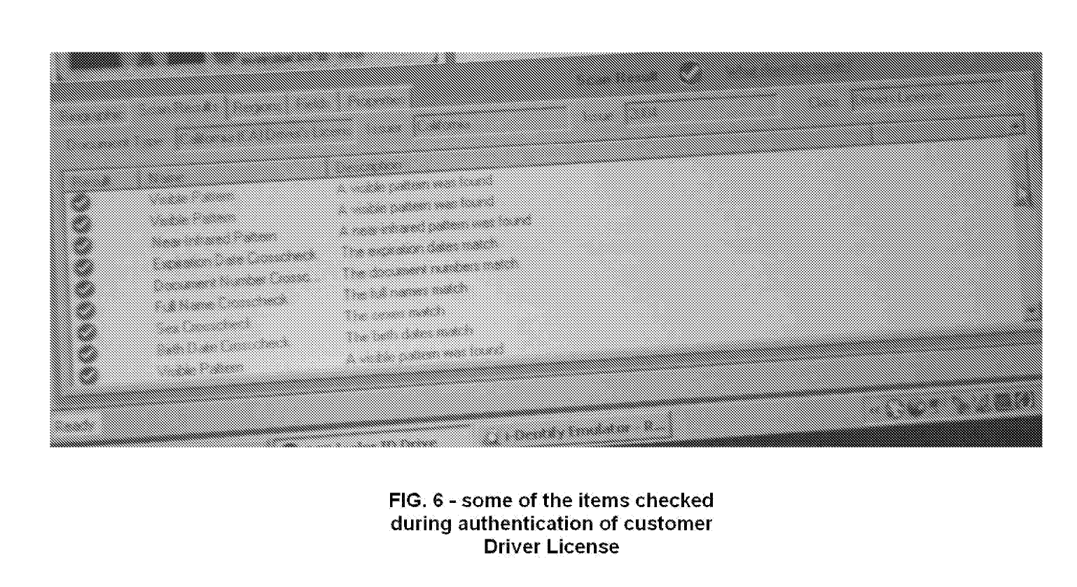

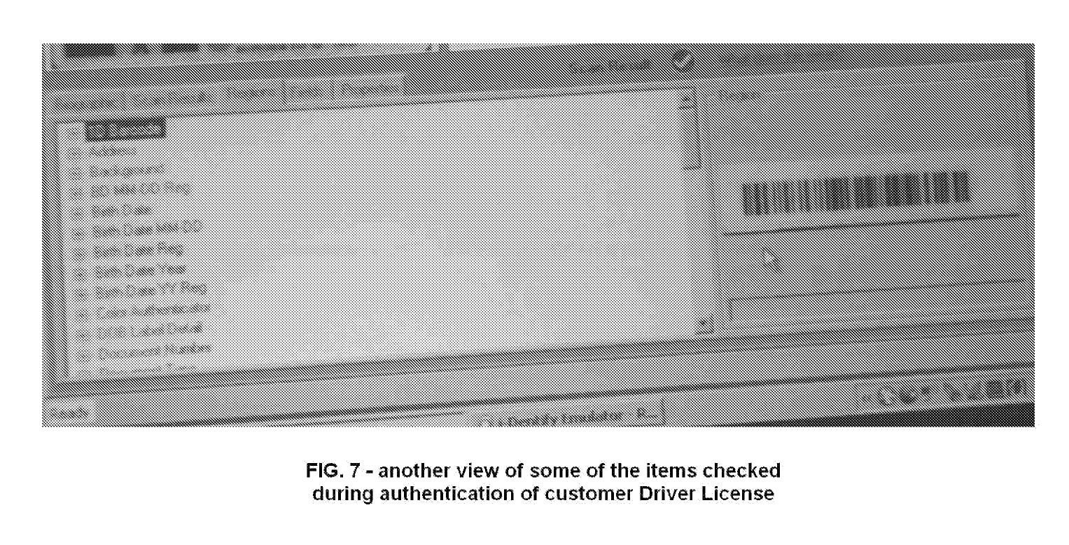

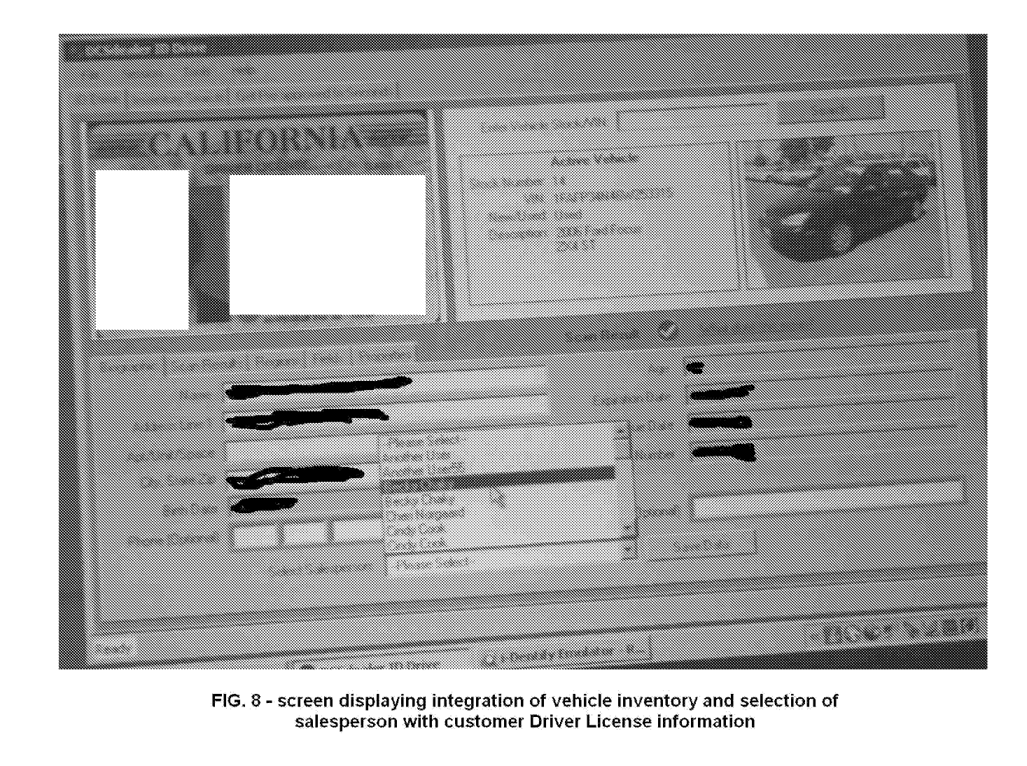

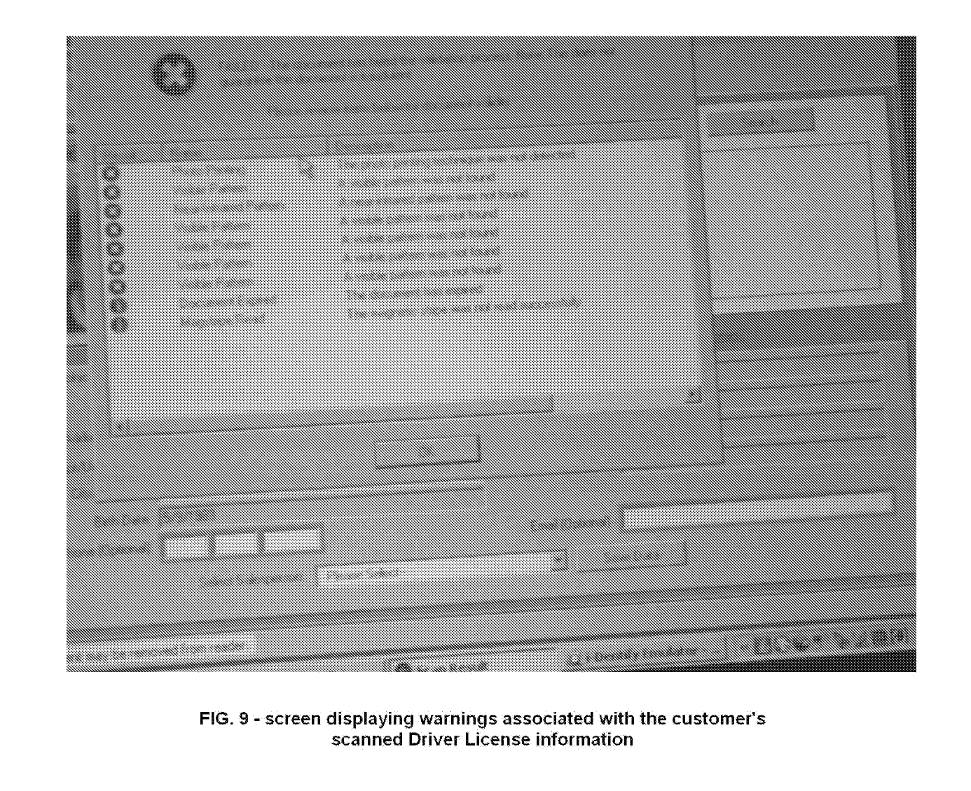

One or more desktop tools (and/or handheld versions, such as illustrated in FIGS. 4A through 4J) for dealer preferably are provided and reflect any of a range of useful information. Among other things, these tools preferably allow dealers to structure transactions for their vehicles. In preferred embodiments, dealers can create a deal structure on the fly that qualifies the customer based on data such as the customer's credit report data (credit score, credit history, etc.), vehicle, pricing, allowable loan-to-value for financing, length of financing term, and/or payment amounts. Preferably all of this data is tied together in the desktop/handheld tool. Also preferably, the dealer can customize the framework it prefers for limits on various financing parameters or other purposes.

Preferably, the system of the invention allows tight integration between dealer SALES and dealer FINANCING departments.

Before the customer even starts the test drive, the dealer can use the information from the desktop/handheld tool to determine whether the customer would even qualify for the car being test-driven (and not waste a test drive on a car that the customer will not qualify to purchase) and/or to suggest more and/or different (and possibly more appropriate/affordable/expensive) models for the customer to consider.

Special financing programs (such as ones from the vehicle manufacturer) preferably can be integrated within the system, so that all such options are reviewed and considered and presented to the dealer/salesperson/finance manager automatically. The system preferably automatically flags any aspects of a proposed deal that do NOT meet the dealer's requirements/pre-set parameters, and automatically updates the displays as the manager modifies various data in certain displayed fields (so that the manager can brainstorm and play with a variety of approaches for a given customer). Among other things, the manager can also input information/limits expressed by the customer, and have real-time calculations of how close the parties may be to an agreement. The dealer may be able to determine that the customer can afford a more expensive vehicle, or additional features on the current model, etc.

The inventory module preferably includes photos, videos, mileage, safety, and/or all other available data for each vehicle within the dealer's stock. That data (and or filtered sets of same) can be made available to the salesperson and/or to the customer, to assist in the negotiations.

Preferably, the system also can run the data/negotiation against various lender programs.

Some/most of the methods and apparatus discussed herein preferably also can be utilized in embodiments over the Internet, allowing the customer to initiate and/or continue the process/negotiation before or after the physical visit to the dealership. Among other things, and by way of example, a dealer can incorporate one or more of the tools into the dealer's website and facilitate such interactions outside of the physical dealership.

In still other embodiments, the system of the invention can be used in connection with a “virtual dealership” and/or “virtual showroom”, so that the consumer orders the specific vehicle they desire, gets qualified for the purchase/lease, receives the contractual documents electronically, and signs and returns same, whereupon the vehicle is manufactured and then delivered to a location convenient for the customer to pick up. Such a “virtual showroom” can be posted by a bank or other institution on the bank's own website or anywhere else on the Internet, allowing a wide variety of promotional and cross-marketing and sales opportunities, and removing a lot of the “friction” that exists in certain prior art systems (such as shopping, selling, purchasing, financing, and/or insuring vehicles or other typically “dealer-financed” items).

Other features in certain embodiments of the invention can include concepts such as allowing a specific customer to track the manufacture and/or delivery of that customer's vehicle.

Persons of ordinary skill in the art will understand that other embodiments of the invention can be used with a wide range of vehicles and other goods, including for example boats, motorcycles, RVs, furniture, and virtually anything else that commonly is a “financed” consumer purchase.

The system preferably allows dealers to view information about what OTHER vehicles the customer may have purchased, test-driven, owned, etc., along with relevant dates for those types of events.

The present invention is described herein with reference to the accompanying Figures, which serve as illustrations of some of the many embodiments in which the invention may be practiced. Subject to the context and other factors (including for example the understanding of persons of ordinary skill in the arts relevant to the inventions), generally in those Figures and references similar reference numerals refer to similar or identical elements throughout this description.

Those Figures and references, and the other terminology used in these descriptions, are not intended to be interpreted in any limited or restrictive manner, simply because it is being utilized in conjunction with a detailed description of certain embodiments of the invention. Furthermore, various embodiments of the invention (whether or not specifically described herein) may include one or more of the novel features disclosed herein, no single one of which (a) is necessarily solely responsible for any particular desirable attribute(s) of the inventions or (b) is essential to practicing the inventions described.

For the purpose of summarizing the invention, certain objects and advantages have been described herein. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein. The apparatus and methods of the invention have been described with some particularity, but the specific designs, constructions, and steps disclosed are not to be taken as delimiting of the invention. A wide range of modifications and alternative structures and steps for practicing the invention will make themselves apparent to those of ordinary skill in the art, all of which will not depart from the essence of the invention, and all such changes and modifications are intended to be encompassed within the appended claims.

Although the examples of the many various methods of the invention are described herein with steps occurring in a certain order, the specific order of the steps, or any continuation or interruption between steps, is not necessarily intended to be required for any given method of practicing the invention.

What is claimed is:

1. Apparatus for vehicle dealership management, including:
Apparatus to capture information relating to a potential customer at a vehicle dealership;
An inventory module for the dealer's inventory of vehicles;
A personnel module for the dealer's sales personnel; and
A computer processor for selecting, modifying, integrating, and displaying the foregoing information in a selected manner.

2. A method of vehicle dealership management, including the steps of:
Providing the apparatus of claim 1; and
Using the apparatus to track test drives of the dealership's vehicles.

3. The method of claim 2, further including the steps of using the apparatus for customer identification validation, financing of purchases, and marketing.

4. The method of claim 3, further including the step of using the apparatus for prevention of identity theft.

5. The apparatus of claim 1, in which the apparatus to capture information is a scanning module.
